(19) United States
(12) Patent Application Publication
(10) Pub. No.: US 2025/0124167 A1
(43) Pub. Date: Apr. 17, 2025

(54) Electronic Devices and Corresponding Methods for Operating Applications in a Security Mode of Operation in Multi-Person Environments

(71) Applicant: Motorola Mobility LLC, Chicago, IL (US)

(72) Inventors: Krishnan Raghavan, Bangalore (IN); Hariprasad Shanbhogue Alampady, Bangalore (IN); Amit Kumar Agrawal, Banagalore (IN)

(21) Appl. No.: 18/380,467

(22) Filed: Oct. 16, 2023

(51) Int. Cl. G06F 21/62; G06Q 40/02

(52) U.S. Cl. CPC G06F 21/6254; G06Q 40/02

(57) ABSTRACT

An electronic device includes a user interface, one or more sensors, a communication device, and one or more processors operable with the user interface, the one or more sensors, and the communication device. The one or more processors determine, with the one or more sensors, whether one or more persons are within a predefined environment of the electronic device. Where only one person is within the predefined environment, the one or more processors operate one or more of a financial application, a messaging application, or a banking application in a normal mode of operation. Where two or more persons are within the predefined environment, the one or more processors operate the one or more of the financial application, the messaging application, or the banking application in a security mode of operation.

### BACKGROUND

### Technical Field

This disclosure relates generally to electronic devices, and more particularly to electronic devices with user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card.

As these devices begin to use more and more financial information, scammers and other miscreants have begun to try and exploit security gaps in either the financial applications of the device or user behavior to commit crimes and steal money. It would be advantageous to have improved devices and systems to prevent situations such as this from occurring.

### BRIEF DESCRIPTION OF THE DRAWINGS

FIG. 1 illustrates one or more explanatory system components and method steps in accordance with one or more embodiments of the disclosure.

FIG. 2 illustrates one explanatory electronic device in accordance with one or more embodiments of the disclosure.

FIG. 3 illustrates one or more explanatory method steps in accordance with one or more embodiments of the disclosure.

FIG. 4 illustrates one explanatory method in accordance with one or more embodiments of the disclosure.

FIG. 5 illustrates one or more explanatory method steps in accordance with one or more embodiments of the disclosure.

FIG. 6 illustrates one or more explanatory method steps in accordance with one or more embodiments of the disclosure.

FIG. 7 illustrates one or more explanatory method steps in accordance with one or more embodiments of the disclosure.

FIG. 8 illustrates one or more method steps in accordance with embodiments of the disclosure.

FIG. 9 illustrates one explanatory electronic device operating in a security mode of operation in accordance with one or more embodiments of the disclosure.

FIG. 10 illustrates one or more embodiments of the disclosure.

FIG. 11 illustrates a prior art method.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to determining whether one or more persons are within a predefined environment of an electronic device, and operating one or more of a financial application, a messaging application, or a banking application in a normal mode of operation when only one person is within the predefined environment, but operating the one or more of the financial application, the messaging application, or the banking application in a security mode of operation when two or more persons are within the predefined environment. Any process descriptions or blocks in flow charts should be understood as representing modules, segments, or portions of code that include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of determining with one or more sensors that two or more persons are within a field of view of a user interface of an electronic device, and where this is the case, precluding the presentation of numerical financial data at the user interface of the electronic device as described herein. The non-processor circuits may include, but are not limited to, a radio receiver, a radio transmitter, signal drivers, clock circuits, power source circuits, and user input devices.

As such, these functions may be interpreted as steps of a method to perform the detection of whether two or more persons are within a predefined environment of an electronic device and, when this is the cases, masking a financial transaction amount or bank balance prior to their presentation on the user interface of the electronic device. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide methods, systems, and electronic devices that can operate one or more of a financial application, a messaging application, or a banking application in a normal mode of operation when only one person is within a predefined environment of an electronic device, but operate that same financial application, messaging application, or banking application in a security mode of operation when two or more persons are within the predefined environment. In one or more embodiments, an electronic device comprises a user interface, one or more sensors, a communication device, and one or more processors operable with the user interface, the one or more sensors, and the communication device. In one or more embodiments, the one or more processors determine, using the one or more sensors, whether one or more persons are within a predefined environment of the electronic device. In one or more embodiments, the predefined environment is defined by a sensor detection range about the electronic device.

In one or more embodiments, when only one person is within the predefined environment, the one or more processors operate one or more of a financial application, a messaging application, or a banking application in a normal mode of operation. However, when two or more persons are within the predefined environment, the one or more processors operate the financial application, the messaging application, or the banking application in a security mode of operation.

In one or more embodiments, the security mode of operation masks numerical financial representations appearing in incoming communications received by the communication device and rendered for presentation on a display by a messaging application. In one or more embodiments, the security mode of operation masks financial transaction amounts rendered for presentation on a display by a financial application. In one or more embodiments, the security mode of operation converts visual prompts generated by one or more of the financial application, the messaging application, or the banking application into audio prompts so a user can hear this information rather than having it be presented on the display for onlookers to see.

In one or more embodiments, the security mode of operation precludes usage of a personal identification number, personal identification gesture, or password to authenticate an authorized user of one or more of the financial application, the messaging application, or the banking application. In one or more embodiments, the security mode of operation further requires entry of a one-time password to authenticate the authorized user of the one or more of the financial application, the messaging application, or the banking application.

Embodiments of the disclosure contemplate that many modern electronic devices include financial applications, messaging applications, and shopping applications. Illustrating by example, Motorola Mobility has launched a banking application called DIMO™ in Brazil. Digital banking applications such as DIMO™ are redefining banking. Indeed, DIMO™ already has over one hundred and fifty thousand accounts in Brazil as it grows toward several million accounts.

This, as well as other, banking applications are redefining the way that banking occurs. Rather than having to go to a bank to physically talk to a teller during business hours to complete a financial transaction, banking applications offer “24-7” banking with instantaneous transfers of money. Banking can be done exclusively using a smartphone. Even automated teller machine (ATM) withdrawals can be made using only a smartphone.

The advent of applications such as DIMO™ are leading to users simply ceasing to carry paper currency or coins. Moreover, applications like DIMO™ have caused people to stop carrying physical credit and debit cards as well since the credit and debit card account information can simply be loaded into a smartphone, with near-field and other communication devices allowing direct transactions of money electronically.

Embodiments of the disclosure also contemplate that as these financial applications and banking applications become more ubiquitous, users of the electronic devices upon which these applications operate can perform banking transactions anywhere. This means that when there is a banking need, a user need not shy away from using their banking application or financial application, even when people may be lurking nearby.

While this seamless usage of financial applications and banking applications offers great convenience, embodiments of the disclosure contemplate that new security issues can arise. Illustrating by example, when onlookers with prying eyes see the output of a banking application or financial application, they may glean sensitive information such as account numbers, personal identification numbers and passwords. Later, if these onlookers are nefarious miscreants, they may use this information to hack the user's account.

Safety issues can also arise. If a miscreant is able to see the display of an electronic device while a financial application or banking application is presenting output, these criminals can access information such as the account balance, transaction history, high value transactions, and so forth. This information could place the user of the electronic device in jeopardy of being robbed or injured.

Privacy concerns can abound as well. Embodiments of the disclosure contemplate that even indifferent bystanders may become curious when another person's banking information is available for view. They may also accidentally see the banking information. Both situations put the user of the banking application's privacy at risk.

Even if everyone within a predefined environment of an electronic device is a law-abiding citizen, awkward situations can arise when financial application or banking application data is visible. Illustrating by example, if attempting to buy dinner for family or friends, it may be difficult for a user to hide the details of the transaction from the family or friends, which can lead to potentially awkward situations.

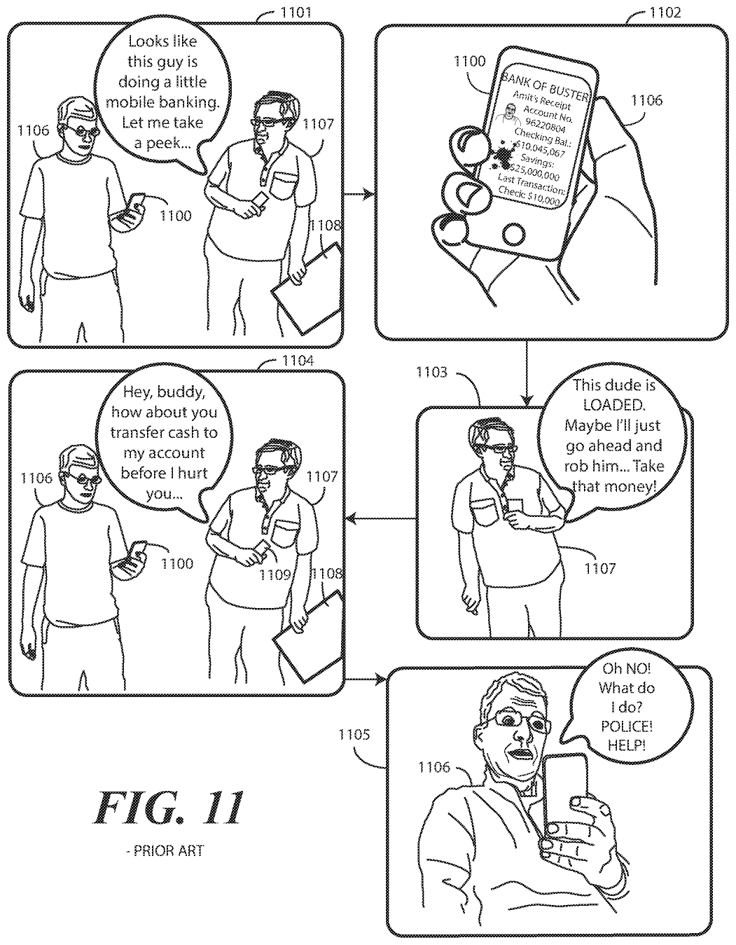

Turning now to FIG. 11, illustrated therein is one prior art method illustrating the problems that can occur in prior art electronic devices. Beginning at step 1101, a user 1106 of an electronic device 1100 is operating a banking application on the electronic device 1100. A shady miscreant 1107 is lurking nearby. The shady miscreant 1107 happens to have a large blunt instrument 1108 in his hand that could conceivably be used to harm the user 1106.

Seeing that the user 1106 is doing some banking, the shady miscreant 1107 decides to “take a little peek” at the display of the electronic device 1100 while the banking application is presenting output. As shown at step 1102, the output of the banking application presented on the display of the electronic device 1100 shows that the user 1106 is quite well off. Indeed, the user 1106 has a checking account balance of over ten million dollars and a savings account balance of over twenty-five million dollars. The last transaction made from the checking account was a check for ten thousand dollars. Even with rampant inflation, to most people this is still a really large amount money.

Upon seeing this, as shown at step 1103, the shady miscreant 1107 says, “This dude is loaded!” Having nefarious thoughts, the shady miscreant 1107 thinks, “maybe I'll just go ahead and rob him.”

At step 1104, the shady miscreant 1107 demands that the user 1106 of the electronic device 1100 transfer a large amount of those funds to the electronic device 1109 of the shady miscreant 1107 to avoid physical harm from the large blunt instrument 1108. As shown at step 1105, the user 1106 is now petrified of the prospect that the shady miscreant 1107 may have noticed the high values of his accounts and transactions and is wondering the accidental share of that information triggered this violent robbery. The user 1106 debates calling the police and rues the day he launched the banking application on his electronic device 1100 with the shady miscreant 1107 within eye shot of the shady miscreant 1107.

Consider another example where physical harm is not involved. Imagine that Rita has invited her friends to her home for the evening. As the evening wears on, Rita orders some additional drinks.

As Rita tries to complete the financial transaction for the drinks, imagine that her friend, Manoj, is sitting next to her. Now imagine that Manoj unintentionally notices the reasonably high value of the financial transaction. This can cause awkwardness when he asks Rita if she would like him to share the expense. This may require Rita to leave the scene to find a quiet corner of the house to finalize the financial transaction without onlookers.

Advantageously, embodiments of the disclosure put a stop to this madness, thereby allowing users of electronic devices to bank or execute financial transactions in peace even when in the company of other people. In one or more embodiments, an electronic device determines if the user of an electronic device is in the company of other people. This can be done in a variety of ways.

In one or more embodiments, in one or more embodiments a camera or other image capture device of the electronic device can determine whether more than one person is gazing at the electronic device. When the electronic device is in a public location such as an office building, train station, or restaurant, one or more processors of the electronic device may presume multiple persons are within the environment of the electronic device.

In other embodiments, near-field communication devices can determine that there are other unknown devices within the predefined environment of the electronic device, thereby making it likely that other people can see the display of the electronic device. In still other embodiments, user input can cause the electronic device to enter a security mode of operation manually, thereby indicating that multiple persons are within the environment of the electronic device.

In one or more embodiments, when multiple people are within the environment of the electronic device, the one or more processors morph the behavior or one or more applications. Illustrating by example, for a banking application, the one or more processors may mask values of incoming messages such as short message system text messages or banking application notifications. The one or more processors may also mask the bank balance of a banking application by default when operating in a security mode of operation.

For banking transactions within a bap, the one or more processors may mask the amounts, replace user interface prompts with audio prompts to be delivered via a headset or headphones, or can replace personal identification numbers, patterns, passwords, with text-based one-time password usage automatically. In one or more embodiments, the one or more processors return the applications to a normal mode of operation when the user exits the multi-person situation.

In one or more embodiments, an electronic device comprises a user interface, one or more sensors, and one or more processors operable with the user interface and the one or more sensors. In one or more embodiments, the one or more processors, in response to an application operating on the one or more processors rendering numerical financial data for presentation on the user interface, determine with the one or more sensors that two or more persons are within a field of view of the user interface. In one or more embodiments, when this occurs, the one or more processors preclude the presentation of the numerical financial data at the user interface.

This preclusion of the presentation of numerical financial data can take different forms. In one or more embodiments, the one or more processors preclude the presentation of the numerical financial data by masking the numerical financial data. In other embodiments, the one or more processors preclude the presentation of the numerical financial data on the user interface by converting the numerical financial data to audio signals for delivery to a companion audio output device such as headphones or ear buds.

In one or more embodiments, a method in an electronic device comprises detecting, with one or more, an application operating on the one or more processors rendering a financial transaction amount or bank balance for presentation on the user interface. One or more sensors then determine that two or more persons are within the predefined environment of the electronic device. When this is the case, the one or more processors mask the financial transaction amount or bank balance prior to their presentation on the user interface.

The problem with prior art systems is that an unauthorized user, which could be a friend, stranger, nosy coworker, or other person, may have the display of an electronic device within their line of sight when financial application or banking application data is being presented. When this occurs, they may be able to surmise personal and confidential information of a person at a minimum, and if nefarious, may even decide to steal from a person with large sums of money. If an unscrupulous person obtains personal information associated with the banking application or financial application, this unscrupulous person may attempt to access the financial application or banking application using the same, thereby gaining access to the authorized user's financial accounts.

Advantageously, embodiments of the disclosure prevent this from happening. In one or more embodiments, one or more processors of an electronic device determine, with one or more sensors, whether one or more persons are within a predefined environment of the electronic device. Where only one person is within the predefined environment, the one or more processors cause one or more of messaging applications, financial applications, and/or banking applications to work in a normal mode of operation. By contrast, where two or more persons are within the predefined environment, the one or more processors can instead cause the one or more of the messaging applications, the financial applications, or the banking applications to enter a security mode of operation. In the security mode of operation, the one or more processors can preclude the presentation of financial transaction amounts or numerical financial data. This preclusion step prevents an unauthorized user from spying on the display in an effort to see the same.

In one or more embodiments, a user can override this preclusion. Such an override may be warranted, for example, where the other person is the spouse of the authorized user. Alternatively, an authorized user may override the preclusion when the other person is a trusted friend, and so forth.

In one or more embodiments, the one or more processors of the electronic device may present indicia, such as one or more prompts, when the preclusion occurs. Illustrating by example, in one or more embodiments, the one or more processors may present a prompt on the display when two or more persons are within the predefined environment about the electronic device requesting the electronic device be moved to a location where the only one person is within the predefined environment. Such a prompt may say, “Multiple persons have been detected, which may compromise security. Please move to a private location for numerical financial data presentation to be enabled.” Other prompts will be obvious to those of ordinary skill in the art having the benefit of this disclosure.

In one or more embodiments, the one or more processors may simply present an informational prompt on the display where two or more persons are within the predefined embodiment. For instance, the prompt may include indicia indicating that numerical financial data is being masked. Such a prompt may say, “balances and financial transaction amounts are masked by default.” The prompts may further indicate why the financial transaction amounts and numerical financial data have been masked. Such a prompt may say, “Multiple persons have been detected. For your safety and security, as well as the safety and security of your data, numerical financial data will not be shown.” Other prompts will be obvious to those of ordinary skill in the art having the benefit of this disclosure.

Where an override is allowed, the one or more processors may prompt, at the display when the two or more persons are within the predefined environment, for the entry of a predefined user input overriding the preclusion of numerical financial data presentation. Such a prompt may say, “Would you like to override this security feature despite the fact that someone might see your numerical financial data?” In response to such a prompt, when the user desires to override the preclusion, the one or more processors may require a one-time password that is received by text message to authenticate the person as the authorized user of the electronic device. When such an override input is received, i.e., after the one or more processors receive the override input, the one or more processors may then allow the messaging application, financial application, or banking application to operate in the normal mode of operation.

Advantageously, embodiments of the disclosure provide a solution to situations in which a person other than the authorized user or device owner is nearby at a viewing angle where the display is visible when the authorized user is operating a banking application or financial application. In one or more embodiments, if the authorized user is not alone and desires to launch a financial application or banking application, the one or more processors of the electronic device preclude the presentation of numerical financial data by masking the same on the display of the electronic device. However, in some embodiments if the authorized user covers the display with a hand, this is detected by one or more sensors of the electronic device and the financial application or banking application is allowed to operate in a normal mode of operation. Similarly, in other embodiments if the authorized user moves to a private area, the one or more sensors detect that the second person is no longer within the predefined environment of the electronic device and the presentation of numerical financial data is allowed when applications operate in a normal mode of operation.

Where the sensors of the electronic device determine that the person is in a public setting, the one or more processors can automatically transition one or more of a messaging application, financial application, or banking application to a security mode of operation. When the electronic device is sitting on a table and in a locked state, in one or more embodiments an imager is actuated when the electronic device is moved. In one or more embodiments, when this occurs the imager determines whether the electronic device is in a public or private setting. If the setting is public, the presentation of numerical financial data will be precluded. It should be noted that, in one or more embodiments, rather than sensors determining the electronic device is in a public setting, the user can deliver user input to the electronic device to cause messaging applications, financial applications, and/or banking applications to operate in a security mode of operation.

When applications are operating in the security mode of operation, an imager or audio sensor can detect that the person is the only person in the environment, perhaps by capturing images of the electronic device being tightly coupled with the user or by a light sensor indicating shadows when the user covers the display with the hand. Where this occurs, the one or more processors may allow the presentation of numerical financial data. Thus, in one or more embodiments when a user is attempting to use a financial application or banking application in a public environment, the presentation of numerical financial data is masked or precluded. In one or more embodiments a prompt is presented on the display indicating why this security mode of operation is occurring, as described above.

Advantageously, when someone, such as a friend or family member or a stranger, is detected to be looking at a display of an electronic device and is within a readable range/distance from the electronic device, the presentation of numerical financial data is disabled. Reasons why this is occurring can be presented on the display so that the user understands what is happening. During such security mode of operations, one or more processors of the electronic device can provide other options to override the security mode of operation, one example of which is the use of a one-time password.

In one or more embodiments, in this non-private compromised security setting, in addition to precluding the presentation of numerical financial data, a prompt is presented to the user notifying them that the numerical financial data is being masked on the display because it can be read by someone near. For example, the prompt may indicate another person is looking from a certain direction and is within a predefined distance of the electronic device and the background lighting is such that the other person can likely read the display.

In one or more embodiments, the user can still enable a normal mode of operation if they choose by turning to face the person and/or crowd making display content non viewable by others, or alternatively by covering the display. This prompt to act reinforces how users should always behave in the presence of others when accessing financial applications or banking applications. Moreover, specific instructions on how to act provide a call to action that can be more likely to make the user act than by simply notifying user he is not in a private setting. Other embodiments are explained below. Still others will be obvious to those of ordinary skill in the art having the benefit of this disclosure.

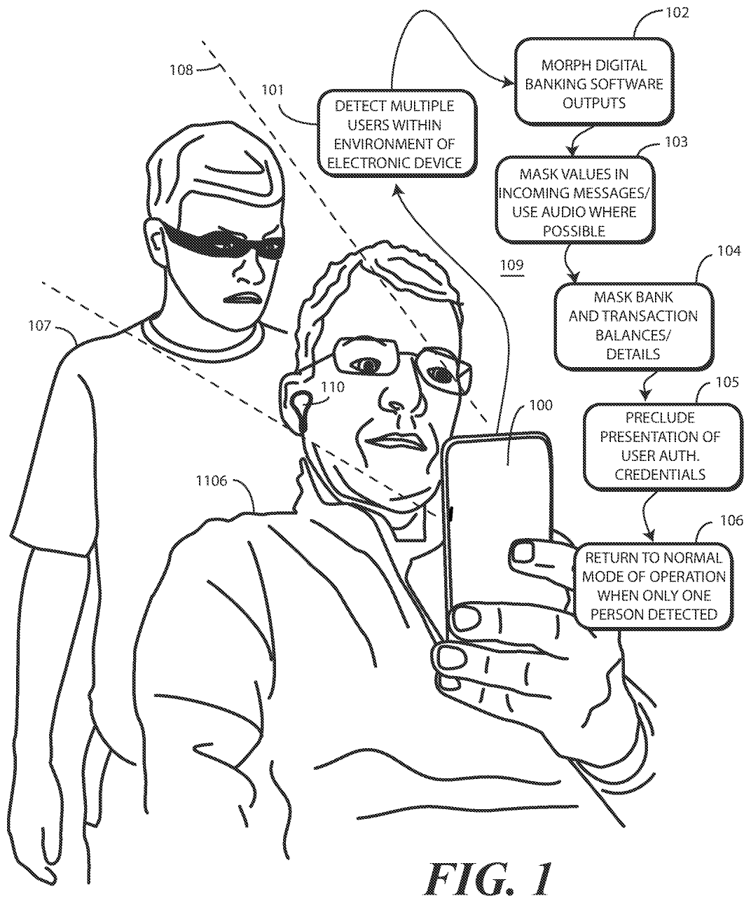

Turning now to FIG. 1, illustrated therein are one or more method steps depicting how the dreadful situation illustrated in FIG. 11 can be avoided using embodiments of the disclosure. As shown, our dear user 1106 is again in the vicinity of a nefarious actor 107. However, the user 1106 is in a much better position because he is now equipped with an electronic device 100 configured in accordance with one or more embodiments of the disclosure.

In one or more embodiments, the electronic device 100 includes a user interface, one or more sensors, and one or more processors operable with the one or more sensors. In one or more embodiments, the one or more processors, in response to an application operating on the one or more processors rendering numerical financial data for presentation on the user interface, determine with the one or more sensors whether two or more people are within a field of view 108 of the user interface. Where this is the case, as is the situation in FIG. 1, the one or more processors preclude the presentation of the numerical financial data on the user interface.

Beginning at step 101, the one or more processors of the electronic device 100 determine whether one or more persons are within a predefined environment 109 of the electronic device 100. As noted above, in one or more embodiments the predefined environment 109 is defined by a person detection radius associated with the one or more sensors of the electronic device 100.

In this case, step 101 results in the one or more processors of the electronic device 100 determining that both the user 1106 and the nefarious actor 107 are within the predefined environment 109. Accordingly, at step 102 the one or more processors operate one or more of a financial application, a messaging application, or a banking application operating on the one or more processors in a security mode of operation. The security mode of operation can take a variety of forms.

In one or more embodiments, as show at step 103, the security mode of operation can perform a masking function. Illustrating by example, of the user 1106 is operating a financial application on the electronic device 100, in one or more embodiments step 103 masks numerical financial data rendered for presentation on the user interface of the electronic device. Step 103 can also mask financial transaction amounts rendered for presentation on the user interface of the electronic device 100. Step 103 can also comprise masking financial transaction amounts rendered for presentation on the user interface by a financial application as well.

In one or more embodiments, step 103 comprises converting visual prompts generated by one or more of a financial application, messaging application, or banking application into audio prompts. In one or more embodiments, these audio prompts can be delivered by the communication device of the electronic device 100 to a companion audio device 110, one example of which is the ear bud shown in FIG. 1. This allows the user 1106 to hear the financial information privately rather than having the same be presented on the display of the electronic device 100.

In one or more embodiments, step 104 comprises masking numerical financial representation appearing in incoming communications received by the communication device of the electronic device that are rendered for presentation on the user interface by a messaging application. In one or more embodiments, step 105 comprises precluding the usage of any personal identification number, personal identification gesture, or password to authenticate the user 1106 as an authorized user of one or more of a financial application, messaging application, or banking application. Step 105 can further require entry of a one-time password to authenticate the user 1106 to one or more of the messaging application, financial application, or banking application.

At step 106, when the one or more sensors of the electronic device 100 determine that only one person is within the predefined environment 109 of the electronic device 100, the one or more processors operate the banking application, messaging application, and/or financial application in a normal mode of operation.

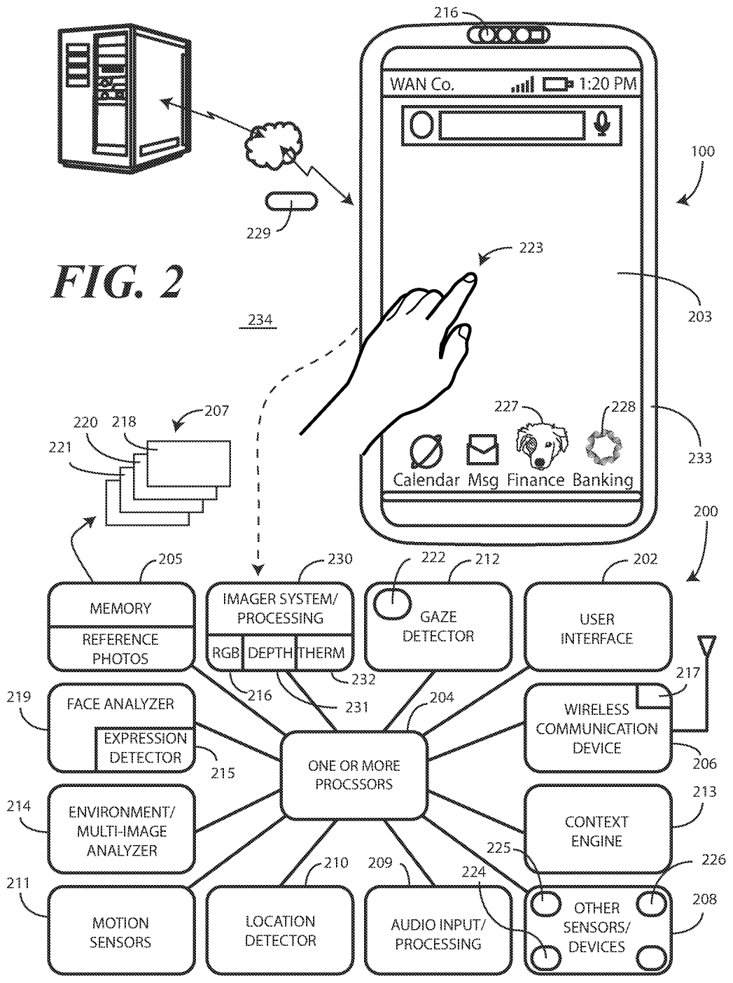

Turning now to FIG. 2, illustrated therein is one explanatory block diagram schematic 200 of one explanatory electronic device 100 configured in accordance with one or more embodiments of the disclosure. The electronic device 100 can be one of various types of devices. In one embodiment, the electronic device 100 is a portable electronic device, one example of which is a smartphone that will be used in the figures for illustrative purposes. However, it should be obvious to those of ordinary skill in the art having the benefit of this disclosure that the block diagram schematic 200 could be used with other devices as well, including conventional desktop computers, palm-top computers, tablet computers, gaming devices, media players, wearable devices, or other devices. Still other devices will be obvious to those of ordinary skill in the art having the benefit of this disclosure.

In one or more embodiments, the block diagram schematic 200 is configured as a printed circuit board assembly disposed within a housing 233 of the electronic device 100. Various components can be electrically coupled together by conductors, or a bus disposed along one or more printed circuit boards.

The illustrative block diagram schematic 200 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

The illustrative block diagram schematic 200 includes a user interface 202. In one or more embodiments, the user interface 202 includes a display 203, which may optionally be touch-sensitive. In one embodiment, users can deliver user input to the display 203 of such an embodiment by delivering touch input from a finger, stylus, or other objects disposed proximately with the display 203. In one embodiment, the display 203 is configured as an active matrix organic light emitting diode (AMOLED) display. However, it should be noted that other types of displays, including liquid crystal displays, suitable for use with the user interface 202 would be obvious to those of ordinary skill in the art having the benefit of this disclosure.

The explanatory electronic device 100 of FIG. 2 includes a housing 233. Features can be incorporated into the housing 233. Examples of features that can be included along the housing 233 include an imager 216, shown as a camera in FIG. 2, or an optional speaker port. A user interface component, which may be a button or touch sensitive surface, can also be disposed along the housing 233.

In one embodiment, the electronic device includes one or more processors 204. In one embodiment, the one or more processors 204 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 200. Each of the application processor and the auxiliary processor(s) can be configured to process and execute executable software code to perform the various functions of the electronic device with which the block diagram schematic 200 operates. A storage device, such as memory 205, can optionally store the executable software code used by the one or more processors 204 during operation.

In this illustrative embodiment, the block diagram schematic 200 also includes a communication circuit 206 that can be configured for wired or wireless communication with one or more other devices or networks. The networks can include a wide area network, a local area network, and/or personal area network. The communication circuit 206 may also utilize wireless technology for communication, such as, but are not limited to, peer-to-peer or ad hoc communications such as HomeRF, Bluetooth and IEEE 802.11-based; and other forms of wireless communication such as infrared technology. The communication circuit 206 can include wireless communication circuitry, one of a receiver, a transmitter, or transceiver, and one or more antennas.

The electronic device 100 can optionally include a near field communication circuit 217 used to exchange data, power, and electrical signals between the electronic device 100 and another electronic device. In one embodiment, the near field communication circuit 217 is operable with a wireless near field communication transceiver, which is a form of radio-frequency device configured to send and receive radio-frequency data to and from the companion electronic device or other near field communication objects.

Where included, the near field communication circuit 217 can have its own near field communication circuit controller in one or more embodiments to wirelessly communicate with companion electronic devices using various near field communication technologies and protocols. The near field communication circuit 217 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 204 can be responsible for performing the primary functions of the electronic device with which the block diagram schematic 200 is operational. For example, in one embodiment the one or more processors 204 comprise one or more circuits operable with the user interface 202 to present presentation information to a user. When a financial application 227 or banking application 228 is operating on the one or more processors 204, this information can include numerical financial data, financial transaction amounts, bank balances, or numerical financial representations.

The executable software code used by the one or more processors 204 can be configured as one or more modules 207 that are operable with the one or more processors 204. Such modules 207 can store instructions, control algorithms, and so forth.

In one embodiment, the one or more processors 204 are responsible for running the operating system environment 218. The operating system environment 218 can include a kernel, one or more drivers, and an application service layer 220, and an application layer 221. The operating system environment 218 can be configured as executable code operating on one or more processors or control circuits of the electronic device 100.

The application service layer 220 can be responsible for executing application service modules. The application service modules may support one or more applications or “apps.” Examples of such applications include a cellular telephone application for making voice telephone calls, a web browsing application configured to allow the user to view webpages on the display 203 of the electronic device 100, an electronic mail application configured to send and receive electronic mail, a photo application configured to organize, manage, and present photographs on the display 203 of the electronic device 100, and a camera application for capturing images with the imager 216. Collectively, these applications constitute an “application suite.” In one or more embodiments, these applications comprise one or more financial applications 227 and/or banking applications 228 that allow financial transactions to be made using the electronic device 100. Illustrating by example, in one or more embodiments a user can deliver user input 223 to a financial application 227 or a banking application 228 to initiate a financial transaction initiation communication 229.

In one or more embodiments, the one or more processors 204 are responsible for managing the applications and all personal information received from the user interface 202 that is to be used by the finance application 227 and/or banking application 228 after the electronic device 100 is authenticated as a secure electronic device and the user identification credentials have triggered a login event. The one or more processors 204 can also be responsible for launching, monitoring and killing the various applications and the various application service modules. In one or more embodiments, the one or more processors 204 are operable to not only kill the applications, but also to expunge any and all personal data, data, files, settings, or other configuration tools when the electronic device 100 is reported stolen or when the finance application 227 and/or banking application 228 are used with fraudulent activity to wipe the memory 205 clean of any personal data, preferences, or settings of the person previously using the electronic device 100.

In one or more embodiments, the block diagram schematic 200 includes an audio input/processor 209. The audio input/processor 209 can include hardware, executable code, and speech monitor executable code in one embodiment. The audio input/processor 209 can include, stored in memory 205, basic speech models, trained speech models, or other modules that are used by the audio input/processor 209 to receive and identify voice commands that are received with audio input captured by an audio capture device. In one embodiment, the audio input/processor 209 can include a voice recognition engine. Regardless of the specific implementation utilized in the various embodiments, the audio input/processor 209 can access various speech models to identify speech commands.

In one embodiment, the audio input/processor 209 is configured to implement a voice control feature that allows a user to speak a specific device command to cause the one or more processors 204 to execute a control operation. For example, the user may say, “Authenticate Me Now.” This statement comprises a device command requesting the one or more processors to cooperate with the imager processor system 230 to authenticate a user. Consequently, this device command can cause the one or more processors 204 to access the imager processor system 230 and begin the authentication process. In short, in one embodiment the audio input/processor 209 listens for voice commands, processes the commands and, in conjunction with the one or more processors 204, performs a touchless authentication procedure in response to voice input.

Various sensors can be operable with the one or more processors 204. FIG. 2 illustrates several examples such sensors. It should be noted that those shown in FIG. 2 are not comprehensive, as others will be obvious to those of ordinary skill in the art having the benefit of this disclosure. Additionally, it should be noted that the various sensors shown in FIG. 2 could be used alone or in combination. Accordingly, many electronic devices will employ only subsets of the sensors shown in FIG. 2, with the particular subset defined by device application.

A first example of a sensor that can be included with the other components 208 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 204, to detect an object in close proximity with—or touching—the surface of the display 203 or the housing 233 of an electronic device 100 by establishing electric field lines between pairs of capacitive sensors and then detecting perturbations of those field lines.

The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Further, it is capable of being deposited in thin layers by way of a printing process. The capacitive sensors may also be deposited on the substrate by electron beam evaporation, physical vapor deposition, or other various sputter deposition techniques.

Another example of a sensor is a geo-locator that serves as a location detector 210. In one embodiment, location detector 210 is able to determine location data when the touchless authentication process occurs by capturing the location data from a constellation of one or more earth orbiting satellites, or from a network of terrestrial base stations to determine an approximate location. Examples of satellite positioning systems suitable for use with embodiments of the present invention include, among others, the Navigation System with Time and Range (NAVSTAR) Global Positioning Systems (GPS) in the United States of America, the Global Orbiting Navigation System (GLONASS) in Russia, and other similar satellite positioning systems. The satellite positioning systems based location fixes of the location detector 210 autonomously or with assistance from terrestrial base stations, for example those associated with a cellular communication network or other ground based network, or as part of a Differential Global Positioning System (DGPS), as is well known by those having ordinary skill in the art. The location detector 210 may also be able to determine location by locating or triangulating terrestrial base stations of a traditional cellular network, such as a CDMA network or GSM network, or from other local area networks, such as Wi-Fi networks.

One or more motion detectors 211 can be configured as an orientation detector that determines an orientation and/or movement of the electronic device 100 in three-dimensional space. Illustrating by example, the motion detectors 211 can include an accelerometer, gyroscopes, or other device to detect device orientation and/or motion of the electronic device 100. Using an accelerometer as an example, an accelerometer can be included to detect motion of the electronic device. Additionally, the accelerometer can be used to sense some of the gestures of the user, such as one talking with their hands, running, or walking.

The motion detectors 211 can determine the spatial orientation and/or motion of an electronic device 100 in three-dimensional space by, for example, detecting a gravitational direction and acceleration due to applied forces. In addition to, or instead of, an accelerometer, an electronic compass can be included to detect the spatial orientation of the electronic device relative to the earth's magnetic field. Similarly, one or more gyroscopes can be included to detect rotational orientation of the electronic device 100.

A gaze detector 212 can comprise sensors for detecting user's or another onlooker's gaze point. The gaze detector 212 can include an iris scanner 222. The gaze detector 212 can optionally include sensors for detecting the alignment of a user's head in three-dimensional space. Electronic signals can then be processed for computing the direction of user's gaze in three-dimensional space. The gaze detector 212 can further be configured to detect a gaze cone corresponding to the detected gaze direction, which is a field of view within which the user may easily see without diverting their eyes or head from the detected gaze direction. The gaze detector 212 can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector 212 of FIG. 2.

Other components 208 operable with the one or more processors 204 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 208 can also include proximity sensors. The proximity sensors fall in to one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. Illustrating by example, in one the proximity sensor components comprise a signal receiver to receive signals from objects external to the housing 233 of the electronic device 100. In one embodiment, the signal receiver is an infrared signal receiver to receive an infrared emission from an object such as a human being when the human is proximately located with the electronic device 100. In one or more embodiments, the proximity sensor component is configured to receive infrared wavelengths of about four to about ten micrometers. This wavelength range is advantageous in one or more embodiments in that it corresponds to the wavelength of heat emitted by the body of a human being.

Additionally, detection of wavelengths in this range is possible from farther distances than, for example, would be the detection of reflected signals from the transmitter of a proximity detector component. In one embodiment, the proximity sensor components have a relatively long detection range so as to detect heat emanating from a person's body when that person is within a predefined thermal reception radius. For example, the proximity sensor component may be able to detect a person's body heat from a distance of about ten feet in one or more embodiments. The ten-foot dimension can be extended as a function of designed optics, sensor active area, gain, lensing gain, and so forth.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

In one embodiment, the signal receiver of each proximity sensor component can operate at various sensitivity levels so as to cause the at least one proximity sensor component to be operable to receive the infrared emissions from different distances. For example, the one or more processors 204 can cause each proximity sensor component to operate at a first “effective” sensitivity so as to receive infrared emissions from a first distance. Similarly, the one or more processors 204 can cause each proximity sensor component to operate at a second sensitivity, which is less than the first sensitivity, so as to receive infrared emissions from a second distance, which is less than the first distance. The sensitivity change can be effected by causing the one or more processors 204 to interpret readings from the proximity sensor component differently.

By contrast, proximity detector components include a signal emitter and a corresponding signal receiver. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

The other components 208 can optionally include a barometer operable to sense changes in air pressure due to elevation changes or differing pressures of the electronic device 100. Where included, in one embodiment the barometer includes a cantilevered mechanism made from a piezoelectric material and disposed within a chamber. The cantilevered mechanism functions as a pressure sensitive valve, bending as the pressure differential between the chamber and the environment changes. Deflection of the cantilever ceases when the pressure differential between the chamber and the environment is zero. As the cantilevered material is piezoelectric, deflection of the material can be measured with an electrical current.

The other components 208 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 100. Similarly, a temperature sensor can be configured to monitor temperature about an electronic device. The other components 208 can also include a flash 224. The other components 208 can also include a fingerprint sensor 225 or retina scanner 226.

A context engine 213 can then be operable with the various sensors to detect, infer, capture, and otherwise determine persons and actions that are occurring in an environment about the electronic device 100. For example, where included one embodiment of the context engine 213 determines assessed contexts and frameworks using adjustable algorithms of context assessment employing information, data, and events. These assessments may be learned through repetitive data analysis. Alternatively, a user may employ the user interface 202 to enter various parameters, constructs, rules, and/or paradigms that instruct or otherwise guide the context engine 213 in detecting multi-modal social cues, emotional states, moods, and other contextual information. The context engine 213 can comprise an artificial neural network or other similar technology in one or more embodiments.

In one or more embodiments, the context engine 213 is operable with the one or more processors 204. In some embodiments, the one or more processors 204 can control the context engine 213. In other embodiments, the context engine 213 can operate independently, delivering information gleaned from detecting multi-modal social cues, emotional states, moods, and other contextual information to the one or more processors 204. The context engine 213 can receive data from the various sensors. In one or more embodiments, the one or more processors 204 are configured to perform the operations of the context engine 213.

In one illustrative embodiment, the imager processor system 230 includes an imager 216 and a depth imager 231. The imager processor system 230 can optionally include a thermal sensor 232. In one embodiment, the imager 216 comprises a two-dimensional imager configured to receive at least one image of a person within an environment of the electronic device 100. In one embodiment, the imager 216 comprises a two-dimensional RGB imager. In another embodiment, the imager 216 comprises an infrared imager. Other types of imagers suitable for use as the imager 216 of the authentication system will be obvious to those of ordinary skill in the art having the benefit of this disclosure.

The thermal sensor 232, where included, can also take various forms. In one embodiment, the thermal sensor 232 is simply a proximity sensor component included with the other components 208. In another embodiment, the thermal sensor 232 comprises a simple thermopile. In another embodiment, the thermal sensor 232 comprises an infrared imager that captures the amount of thermal energy emitted by an object. Other types of thermal sensors 232 will be obvious to those of ordinary skill in the art having the benefit of this disclosure.

The depth imager 231 can take a variety of forms. In a first embodiment, the depth imager 231 comprises a pair of imagers separated by a predetermined distance, such as three to four images. This “stereo” imager works in the same way the human eyes do in that it captures images from two different angles and reconciles the two to determine distance.

In another embodiment, the depth imager 231 employs a structured light laser. The structured light laser projects tiny light patterns that expand with distance. These patterns land on a surface, such as a user's face, and are then captured by an imager. By determining the location and spacing between the elements of the pattern, three-dimensional mapping can be obtained.

In still another embodiment, the depth imager 231 comprises a time of flight device. Time of flight three-dimensional sensors emit laser or infrared pulses from a photodiode array. These pulses reflect back from a surface, such as the user's face. The time it takes for pulses to move from the photodiode array to the surface and back determines distance, from which a three-dimensional mapping of a surface can be obtained. Regardless of embodiment, the depth imager 231 adds a third “z-dimension” to the x-dimension and y-dimension defining the two-dimensional image captured by the imager 216, thereby enhancing the security of using a person's face as their password in the process of authentication by facial recognition.

The imager processor system 230 can be operable with a face analyzer 219 and an environmental analyzer 214. The face analyzer 219 and/or environmental analyzer 214 can be configured to determine, for example, whether the user is the only person within a predefined environment 234 of the electronic device 100, or whether multiple people are within the predefined environment 234 of the electronic device 100. The predefined environment 234 is “predefined” because it is defined by a signal reception radius within which the various components 208 of the electronic device 100 can receive reliable signals.

The face analyzer 219 and/or environmental analyzer 214 can also be configured to process an image or depth scan of an object and determine whether the object matches predetermined criteria. For example, the face analyzer 219 and/or environmental analyzer 214 can operate as an identification module configured with optical and/or spatial recognition to identify objects using image recognition, character recognition, visual recognition, facial recognition, color recognition, shape recognition, and the like. Advantageously, the face analyzer 219 and/or environmental analyzer 214, operating in tandem with the imager processor system 230, can be used as a facial recognition device to determine the identity of one or more persons detected about the electronic device 100.

Illustrating by example, in one embodiment when the imager processor system 230 detects a person, one or both of the imager 216 and/or the depth imager 231 can capture a photograph and/or depth scan of that person. The imager processor system 230 can then compare the image and/or depth scan to one or more reference files stored in the memory 205. This comparison, in one or more embodiments, is used to confirm beyond a threshold authenticity probability that the person's face—both in the image and the depth scan—sufficiently matches one or more of the reference files.

Beneficially, this optical recognition performed by the imager processor system 230 operating in conjunction with the face analyzer 219 and/or environmental analyzer 214 allows access to the electronic device 100 only when one of the persons detected about the electronic device are sufficiently identified as the owner of the electronic device 100. Accordingly, in one or more embodiments the one or more processors 204, working with the imager processor system 230 and the face analyzer 219 and/or environmental analyzer 214 can determine whether at least one image captured by the imager 216 matches a first predefined criterion, whether at least one facial depth scan captured by the depth imager 231 matches a second predefined criterion, and whether the thermal energy identified by the thermal sensor 232 matches a third predefined criterion, with the first criterion, second criterion, and third criterion being defined by the reference files and predefined temperature range. The first criterion may be a skin color, eye color, and hair color, while the second criterion is a predefined facial shape, ear size, and nose size. The third criterion may be a temperature range of between ninety-five and one hundred and one degrees Fahrenheit. In one or more embodiments, the one or more processors 204 authenticate a person as an authorized user of the electronic device when the at least one image matches the first predefined criterion, the at least one facial depth scan matches the second predefined criterion, and the thermal energy matches the third predefined criterion.

In one or more embodiments, the face analyzer 219 can also include an image/gaze detection-processing engine. The image/gaze detection-processing engine can process information to detect a user's gaze point. The image/gaze detection-processing engine can optionally also work with the depth scans to detect an alignment of a user's head in three-dimensional space. Electronic signals can then be delivered from the imager 216 or the depth imager 231 for computing the direction of user's gaze in three-dimensional space. The image/gaze detection-processing engine can further be configured to detect a gaze cone corresponding to the detected gaze direction, which is a field of view within which the user may easily see without diverting their eyes or head from the detected gaze direction. The image/gaze detection-processing engine can be configured to alternately estimate gaze direction by inputting images representing a photograph of a selected area near or around the eyes. It can also be valuable to determine if the user wants to be authenticated by looking directly at device. The image/gaze detection-processing engine can determine not only a gazing cone but also if an eye is looking in a particular direction to confirm user intent to be authenticated.

In one or more embodiments, the face analyzer 219 is further configured to detect mood. The face analyzer 219 can infer a person's mood based upon contextual information received from the imager 216 and/or depth imager 231. For example, if a picture, a depth scan, multiple successive pictures, multiple successive depth scans, video, or other information from which a person can be identified as the owner of the electronic device 100 indicate that the owner is crying, the face analyzer 219 can infer that she is either happy or sad.

The face analyzer 219 can similarly determine emotion in one or more embodiments. Illustrating by example, a picture, a depth scan, multiple successive pictures, multiple successive depth scans, video, or other information relating to of the owner of an electronic device can allow an expression detector 215 to determine the inference of their silently communicated emotional state, e.g. joy, anger, frustration, and so forth. This can be inferred from, for example, facial expressions such as a raised eyebrow, grin, or other feature. In one or more embodiments, such emotional cues can be used as a secret password for authentication in addition to the face.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

In one or more embodiments, when an application operating on the one or more processors 204 renders numerical financial data for presentation on the user interface 202, the one or more processors preclude this presentation when two or more persons are within a field of view of the user interface 202. Illustrating by example, if the financial application 227 or banking application 228 attempts to render numerical financial data such as financial transaction amounts or bank balances for presentation on the display 203 of the user interface 202, in one or more embodiments the one or more p 204 are configured to preclude the presentation of this numerical financial data on the user interface 202 when the one or more sensors or other components 208 of the electronic device 100 determine that two or more persons are within a field of view of the display 203 of the user interface 202.

Turning briefly to FIG. 9, illustrated therein is one example depicting how this can occur. As shown in FIG. 9, our dear user 1106 is operating an electronic device 100 configured in accordance with embodiments of the disclosure. A banking application 228 is operating on the one or more processors (204) of the electronic device 100 and is rendering numerical financial data for presentation on the display 203. In this example, the numerical financial data comprises two bank balances, namely, a checking account balance 902 and a savings account balance 903, along with a financial transaction amount 904, which is the amount of the last check drawn from the checking account.

In the example of FIG. 9, the one or more sensors and other components (208) of the electronic device 100 have detected multiple persons within a field of view 108 of the display 203. Accordingly, the one or more processors (204) preclude the presentation of the numerical financial data on the display 203.

In this illustrative embodiment, the one or more processors (204) preclude the presentation of the numerical financial data on the display 203 by masking the numerical financial data. As shown, the numerical financial data corresponding to the checking account balance 902, the savings account balance 903 and the last financial transaction amount 904 have all been masked. As noted above in the description of FIG. 1, in other embodiments the one or more processors (204) may preclude the presentation of the numerical financial data by converting the numerical financial data to audio signals for delivery to a companion audio output device such as earphones or ear buds.

In this illustrative embodiment, the banking application 228 also presents personal data 901 corresponding to the user 1106 in the form of an account number. Since nefarious actors can use such personal data 901 to hack into financial accounts, in this illustrative embodiment the personal data 901 is also masked.

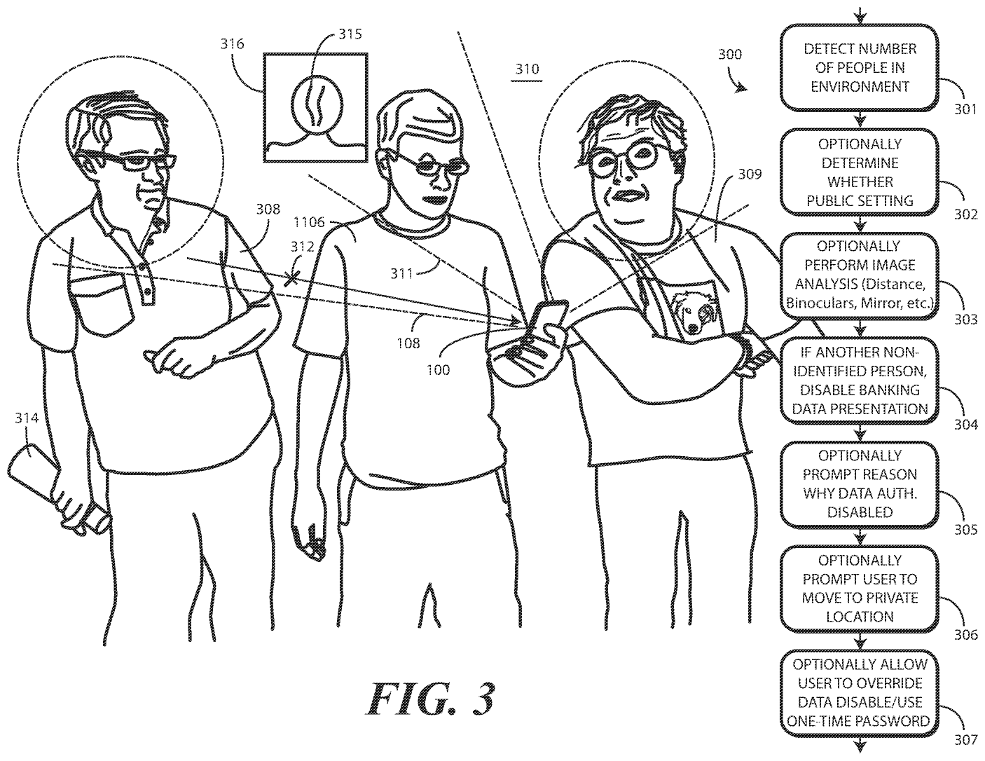

Turning now to FIG. 3, illustrated therein is one explanatory method 300 in accordance with one or more embodiments of the disclosure. As shown, our friendly user 1106 is again attempting to perform some financial transactions using a financial application or banking application operating on one or more processors of an electronic device 100 configured in accordance with one or more embodiments of the disclosure. However, rather than being alone two nefarious actors 308,309 are within the environment 310 of the electronic device 100 from which signals can be received by the one or more sensors of the electronic device 100.

A method 300 is also shown in FIG. 3. The actors 308,309 could be other than nefarious. For example, they could just include a nosy friend or relative. In any event, for the purposes of this illustration, one or more of the actors 308,309 is not an authorized user of the electronic device 100, but desires to gain access to the information stored therein. In particular, one or more of the actors 308,309 desires to get a peek at the bank balance or other numerical financial data rendered by the banking application as the user 1106 is engaging in his financial transactions.

Advantageously, to stop this, at step 301 the method 300 determines, using one or more sensors of the electronic device 100, whether one or more persons are within the predefined environment 310 of the electronic device 100, which in this case there are. This determination can be made in a number of ways.

Illustrating by example, an imager (216) of the electronic device 100 may capture an image of the predefined environment 310. The imager processing system (230), the face analyzer (219), the environmental analyzer (214), the one or more processors (204), or another component of the electronic device 100 can then analyze that image to determine whether multiple persons are within the predefined environment 310.

In other embodiments, step 301 can comprise an audio input/processor (209) capturing audio from the predefined environment 310. The audio input/processors (209) can analyze this audio input to detect multiple persons within the predefined environment 310.

In other embodiments, the depth scanner (231) can capture depth scans of multiple people at step 301. The gaze detector (212) may detect the gaze of more than one person toward the electronic device 100 to determine whether these people are within a field of view 108 of the display (203) of the electronic device 100 at step 301. The communication circuit (206) may detect radio frequency signals coming from electronic devices belonging to the other people within the predefined environment 310 at step 301 as well. Of course, these processes can be performed alone or in combination for greater confidence in the detection of whether multiple persons are within the predefined environment 310.

In a simpler embodiment, the user 1106 simply delivers user input to the user interface (202) of the electronic device 100 at step 301 that indicates two or more people are within the predefined environment 310. Said differently, in one or more embodiments step 301 comprises receiving, from the user interface (202) of the electronic device 100, user input indicating that the two or more persons are within the predefined environment. When the user authentication input user interface is presented, for example, the user may enter #######, rather than a PIN or other authorized user identifier, to alert the one or more processors (204) of the electronic device 100 that multiple persons are within the predefined environment 310. Other techniques for determining whether multiple people are within the predefined environment 310 at step 301 will be obvious to those of ordinary skill in the art having the benefit of this disclosure.

In one or more embodiments, the imager (216) is the primary tool to determine whether one or more persons are within the predefined environment 310. For instance, in one embodiment the one or more processors (204) determine whether the one or more persons are within the predefined environment 310 of the electronic device 100 by capturing, with the imager (216), one or more images of the predefined environment 310. From there, at optional step 303 one or more of the imager processing system (230), the face analyzer (219), the environmental analyzer (214), the one or more processors (204), or another component of the electronic device 100 can perform image analysis on images captured by the imager (216) to detect conditions within the predefined environment 310 that may affect the ability of the two nefarious actors 308,309 to see the display (203) of the electronic device 100.

In other embodiments, this determination of whether multiple persons are within the environment can be performed in other ways. Illustrating by example, at step 302 the electronic device 100 can comprise a location detector (210). In one or more embodiments, step 302 can comprise determining whether one or more processors are within the predefined environment 310 by detecting, from signals from the location detector (210), that the electronic device 100 is in a public location such as an office, a train station, or a restaurant. Where this is the case, it is inferred that multiple people are likely to be within the predefined environment 310.

Like step 301, step 302 can be performed in other ways as well. Illustrating by example, in still other embodiments step 302 can comprise querying a calendaring application operating on the one or more processors (204) to detect a scheduled appointment stored in the calendaring application that identifies a multi-person gathering. If, for example, the calendaring application indicates that the user 1106 is scheduled to go to a party, the one or more processors 204 can infer that multiple people are likely to be within the predefined environment 310.

Where the components and systems of the electronic device 100 determine that two or more persons are within the predefined environment, the one or more processors (204) operate one or more of messaging applications, banking applications, and/or financial applications in a security mode of operation at step 304. In one or more embodiments, step 304 comprises masking, with the one or more processors (204), any financial transaction amounts or the bank balances prior to their presentation on the user interface.

For instance, when speaking of messaging applications, in one or more embodiments step 304 comprises masking numerical financial representations appearing in incoming communications 312 received by the communication device (206) of the electronic device and rendered for presentation on the display (203) of the electronic device. Similarly, as shown in FIG. 9 above, step 304 can comprise masking bank balances (902,903) and financial transaction amounts (904) in banking applications and financial applications.

Thus, where the components and systems of the electronic device 100 conclude that the nefarious actors 308,309 have a line of sight to the display (203) of the electronic device 100, in one or more embodiments the one or more processors (204) will preclude the presentation of numerical financial representations that would ordinarily be rendered by financial applications, banking applications, and messaging applications. However, where the components and systems of the electronic device 100 conclude that the display (203) is not viewable by the nefarious actors 308,309, the one or more processors (204) will allow rendered numerical financial representations to be presented on the display (203) of the electronic device. A few use cases will illustrate conditions for precluding or allowing the presentation of numerical financial data.

Illustrating by example, in one or more embodiments, the imager (216) defines a field of view 108 for the one or more images. As is known in the art, the field of view 108 of the imager is the area of inspection that captured by the imager (216). In many cases, this field of view 108 can be adjusted by adjusting the settings of the imager (216).

In one or more embodiments, the imager (216) is designed such that the field of view 108 can be set to define a viewing angle within which the display (203) can be seen. For instance, in the illustrative embodiment of FIG. 3, the field of view 108 is set wide enough that any person standing within the field of view can likely see the display (203). As shown in FIG. 3, both of the nefarious actors 308,309 are within the field of view 108. Since this is the case, the nefarious actors 308,309 likely can see the display (203) of the electronic device 100. The gaze detector (212) of the electronic device 100 can further confirm this by performing image analysis to detect that, in this illustration, both nefarious actors 308,309 are secretly gazing at the display (203) of the electronic device 100 while the user 1106 is attempting to engage in financial transactions using a banking application or financial application.

Since this is the case, at step 304 the method precludes the presentation of numerical financial representations that would be rendered by the banking application or financial application. It also precludes the presentation of any numerical financial data that might be present in incoming communications 312 that would be rendered for presentation by a messaging application. In short, when the one or more processors (204) of the electronic device 100 detect an application operating on the one or more processors (204) rendering a financial transaction amount or bank balance for presentation on the display (203) and two or more persons are within the predefined environment 310 of the electronic device 100, the one or more processors (204) can mask or otherwise preclude the presentation of the financial transaction amount, bank balance, or numerical financial representations from being exposed by the display (203). Advantageously, this prevents the nefarious actors 308,309 from secretly watching and obtaining personal or financial information belonging to the user 1106.

Embodiments of the disclosure contemplate that there are, however, situations in which the presentation of numerical financial representations would be permissible even when multiple persons are within the environment of the electronic device 100. This is true because whether the actors 308,309 can actually see the electronic device 100 can be an important factor in determining whether to preclude the presentation of numerical financial data.

Illustrating by example, if the nefarious actors 308,309 are too far away from the electronic device 100, it may be possible to allow the presentation of numerical financial data by a banking application, financial application, or messaging application without fear of it being compromised simply because the nefarious actors 308,309 cannot sufficiently see the display (203) of the electronic device 100. However, if the nefarious actors 308,309 were far away but were using binoculars or a telescope, allowing the presentation of numerical financial data could be problematic.

Accordingly, in one or more embodiments the one or more processors (204) of the electronic device 100 verify, at step 303, optionally by analyzing the one or more images, whether a distance between all but one person of the two or more persons is beyond a predefined distance threshold. Alternatively, the imager processing system (230) can determine the distance between the actors 308,309 and the electronic device 100 by using the scaling from the captured images using the depth scanner (231). In other embodiments, proximity detector components can use a signal emitter that transmits a beam of infrared light that reflects from a nearby object and is received by a corresponding signal receiver, which can be used to compute the distance between the nefarious actors 308,309 and the electronic device 100.

Embodiments of the disclosure contemplate that when the nefarious actors 308,309 are beyond a predefined distance from the electronic device 100, they will be unable to discern what is being rendered by the display (203). Accordingly, the preclusion of the presentation of numerical financial data will be unnecessary. As such, in one or more embodiments rather than precluding this presentation, the one or more processors (204) will prompt, at the user interface (202) for entry of a one-time password to authenticate the user 1106 as an authorized user of the electronic device 100 to one or more of the financial application, the banking application, or the messaging application when all but one person, e.g., user 1106, of the people within the predefined environment 310 is beyond a predefined distance threshold.

Embodiments of the disclosure also contemplate there can be scenarios when all of the nefarious actors 308,309 are beyond a predefined distance threshold, but those far-away persons can still see the user interface (202) of the electronic device 100. For example, in one or more embodiments the actors 308,309 may be using binoculars, telescopes, or other auxiliary lensed optical instrument 314. Accordingly, in one or more embodiments step 303 includes the environmental analyzer (214) or other component of the electronic device 100 determining, by analyzing the one or more images 311, whether people within the field of view 108 or within the predefined environment 310 are using an auxiliary lensed optical instrument 314 such as binoculars or a telescope. The term “auxiliary” is used to distinguish distance-based lensed optical instruments, such as binoculars or telescopes, from corrective vision lensed instruments such as eyeglasses and contact lenses. Where any of the people are using an auxiliary lensed optical instrument 314, despite the fact that they are beyond the predefined distance, step 304 will include precluding the presentation of numerical financial data.

Embodiments of the disclosure contemplate that the imager processor system (230), the face analyzer (219), the environmental analyzer (214), the one or more processors (204), or another component of the electronic device 100 can, under certain conditions, initially mistakenly conclude there are multiple persons within the predefined environment 310. This can occur when, for example, a mirror 316 is disposed behind the user 1106. When this happens, the environmental analyzer (214) may think that the reflection 315 of the user 1106 is instead a second person.

Accordingly, in one or more embodiments step 303 includes determining, by analyzing the one or more images, imager processor system (230), the face analyzer (219), the environmental analyzer (214), the one or more processors (204), or another component of the electronic device 100, whether all but one person of the two or more persons is a mirrored reflection 315 of all but one person. Said differently, in one embodiment step 303 comprises determining, with the imager processor system (230), the face analyzer (219), the environmental analyzer (214), the one or more processors (204), or another component of the electronic device 100, whether the perceived other person is a mirror image of the user 1106. Where this is the case, i.e., where all but one person of the two or more persons is the mirrored reflection 315 of all but one person, the one or more processors may skip the precluding of step 304 and will instead render numerical financial data.

Step 304 advantageously prevents an unauthorized user from spying on the display in an effort to see what the authorized user's financial transactions or bank balances are in a banking application or financial application. By contrast, where only one person is within the predefined environment 310, step 304 allows the presentation of all such numerical financial representations. In this illustration, the nefarious actors 308,309 are in the predefined environment 310, can see the display (203), and are gazing at the display (203). Accordingly, the former would be performed, and numerical financial data would be masked or otherwise precluded from presentation.

Embodiments of the disclosure contemplate that it is conceivable that the user 1106 may forget that the preclusion of the presentation of numerical financial data is for their own safety and security. If the user 1106 is particularly absent minded, or is simply having an off day, they may think that the electronic device 100 is not working properly. To ensure this is not the case, in one or more embodiments the one or more processors (204) of the electronic device 100 prompt the user 1106 by presenting helpful indicia on the display (203) or user interface (202) of the electronic device 100.

Illustrating by example, in one embodiment optional step 305 comprises presenting indicia at the user interface (202) of the electronic device 100 when the two or more persons are within the predefined environment 310. In one or more embodiments, these indicia indicates that the presentation of numerical financial data will be masked or otherwise precluded from being displayed to prevent the nefarious actors 308,309 from seeing the same. The indicia might say, “BALANCES AND FINANCIAL TRANSACTIONS MASKED.” Alternatively, the indicia might be a large picture of a STOP sign. Alternatively, the indicia may just be a blank screen where the output of a financial application or banking application would normally appear. Other examples of suitable indicia indicating that the presentation of numerical financial data has been precluded will be obvious to those of ordinary skill in the art having the benefit of this disclosure.

In one or more embodiments, optional step 305 includes not only presenting indicia indicating the presentation of all numerical financial representations from applications is precluded, but why it being is precluded as well. Accordingly, in one or more embodiments step 305 comprises presenting additional indicia, at the user interface (202) when the two or more persons are within the predefined environment 310.

In one or more embodiments the additional indicia indicate why the presentation of numerical financial data has been precluded. The indicia might say, “Look out! Other people can see your bank balance! Numerical financial data masked for your protection!” Alternatively, the indicia might say, “Buster, be careful! People are trying to get your numerical financial data! For this reason, you can't see your bank balance at this time.” In another embodiment, the indicia might just be a giant picture of the World War II era “Kilroy” peeking over a wall, which indicates that other people are watching. Other examples of suitable indicia will be obvious to those of ordinary skill in the art having the benefit of this disclosure.

It should be noted that step 305 is optional, due to the fact that it may be safer not to present anything at all. Where the nefarious actors 308,309 are just nosy family members, presenting step 305 does no harm. However, were the nefarious actors 308,309 actual criminals, presentation of this indicia may tip them off that the electronic device 100 will eventually present some juicy numerical financial data, thereby placing additional pressure on the user 1106 that he does not need. Accordingly, in one or more embodiments step 305 can be included or excluded via adjustments of the user settings of the electronic device 100. A forgetful user might ensure that step 305 occurs, while a mindful user might disable it, and so forth.

In addition to informational prompts and indicia, instructional prompts and indicia can be presented as well. For example, in one or more embodiments optional step 306 comprises prompting, on a user interface (202) of the electronic device, for the electronic device 100 to be moved to a location where the only one person is within the predefined environment. Such a prompt may say, “Buster, Wait! You need to move to a private location so nobody watches you engage in financial transactions!” Alternatively, the prompt may say, “People are watching! Move to a private location BEFORE using your financial application to make financial transactions! Now, man!” Other suitable “move somewhere private” prompts will be obvious to those of ordinary skill in the art having the benefit of this disclosure.

Embodiments of the disclosure contemplate that the two actors 308,309 may not be nefarious. They may be best friends of the user 1106, and the user 1106 may care less whether they see how fat the user's bankroll happens to be. For that matter, the user 1106 may brag all the time about being a baller rolling in the dough. Alternatively, the electronic device 100 may be a shared electronic device, and each of the actors 308,309 may have their banking application or financial application accounts. As such, the user 1106 may desire to override the preclusion of the presentation of numerical financial data. Optional step 307 allows just that.

In one or more embodiments, step 307 requires the entry of a one-time password to authenticate the user 1106 as an authorized user to any financial applications, banking applications, or messaging applications operating on the one or more processors of the electronic device 100. In other embodiments, step 307 comprises prompting, at the user interface (202) of the electronic device 100 when the two or more persons are within the predefined environment 310, for the entry of a user input overriding preclusion the presentation of numerical financial data.

For example, the one or more processors (204) of the electronic device 100 may cause a message to be presented on the display (203) of the electronic device 100. The message may say, “Buster, do you want to override this important security feature and let everyone see all your bling-bling anyway?” Alternatively, the message may say, “Would you like us to send you a one-time password to see all your sweet bread? The message may say, “Speak ‘override’ in your normal tone of voice so that voice analysis can be used to validate that you want this security feature to be overridden.” Other suitable messages will be obvious to those of ordinary skill in the art having the benefit of this disclosure.

In one or more embodiments, step 307 then comprises receiving, from the user interface after the prompting, a one-time password received by a short message service message. In other embodiments user input could override the preclusion at step 307 when that user interface is different than the normal user authentication data used to unlock the electronic device 100.

Illustrating by example, if the user authentication code used to unlock the device is 2-4-6-8-0, the user input to override the preclusion of the presentation of numerical financial data might be BSTRWNTSTVRRIDE, which is “Buster wants to override” without the vowels. Other examples of user input used to override the preclusion of the presentation of the numerical financial data will be obvious to those of ordinary skill in the art having the benefit of this disclosure.

As shown and described with reference to FIG. 3, embodiments of the disclosure provide a solution to situations in which a person other than the authorized user or device owner is nearby at a viewing angle where the display (203) of the electronic device 100 is visible when the authorized user trying to engage in financial transactions using a banking application or financial application. In one or more embodiments, if the authorized user is not alone and desires to engage in a financial transaction, the one or more processors (204) of the electronic device 100 preclude the presentation of numerical financial data on the display (203) of the electronic device 100.

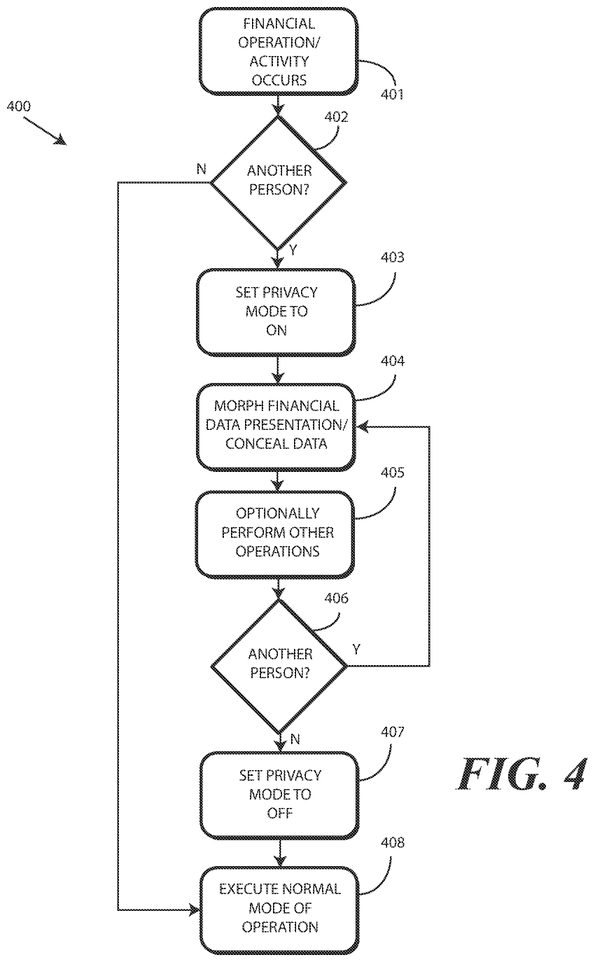

Turning now to FIG. 4, illustrated therein is another explanatory method 400 in accordance with one or more embodiments of the disclosure suitable for use in an electronic device. Beginning at step 401, the method detects, with one or more processors of the electronic device, an application operating on the one or more processors rendering numerical financial data, examples of which include a financial transaction amount or bank balance for presentation on a user interface.

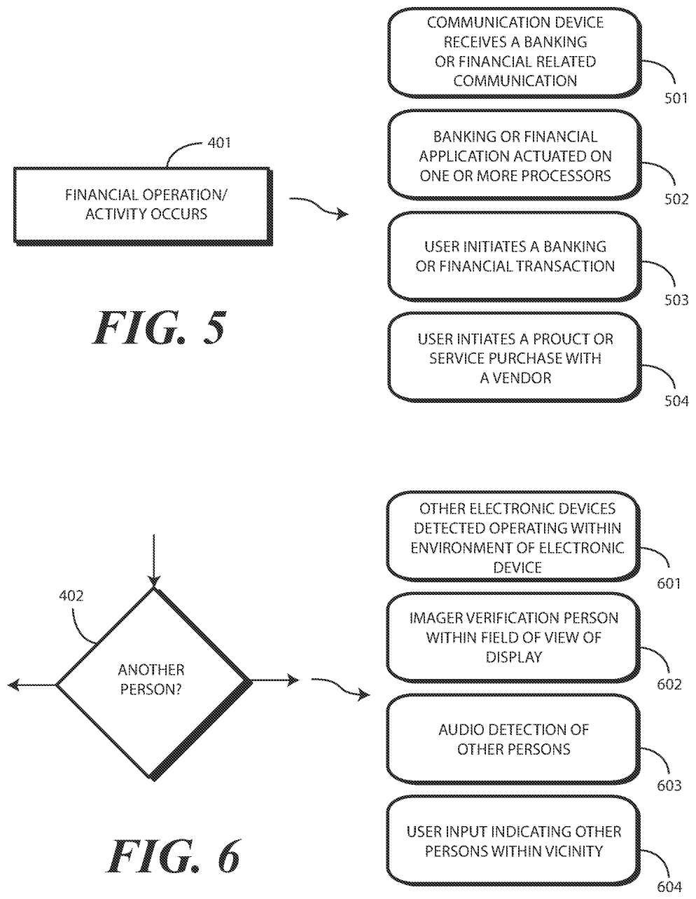

Step 401 can be performed in a variety of ways. Turning briefly to FIG. 5, illustrated therein are a few such ways. Others will be obvious to those of ordinary skill in the art having the benefit of this disclosure.

In one or more embodiments, step 401 comprises a communication device receiving a banking or financial related communication at step 501. Alternatively, step 401 can comprise a banking application or financial application being actuated for operation on one or more processors of an electronic device at step 401.

In still other embodiments, a user may deliver user input to a user interface of the electronic device to initiate a financial transaction using a banking application or financial application at step 403. Similarly, a user may initiate an e-commerce transaction at step 504 to purchase a product or service using an e-commerce application operating on the one or more processors. Other techniques for detecting an application operating on the one or more processors rendering numerical financial data at step 401 will be obvious to those of ordinary skill in the art having the benefit of this disclosure.

Turning now back to FIG. 4, decision 402 then determines, using one or more sensors of the electronic device, whether two or more persons are within a predefined environment of the electronic device. As with step 401, decision 402 can be determined in a number of ways.

Illustrating by example, decision 402 can be made using thermal detection. The electronic device could include proximity sensor components or proximity detector components. The proximity sensor components can be disposed corners of the electronic device. For example, a first proximity sensor component can be disposed at a first corner of the electronic device, while a second proximity sensor component can be disposed at a second corner of the electronic device, and so forth. Similarly, proximity sensor components can be disposed about a perimeter of the electronic device as well.

Each proximity sensor component can be disposed behind a grille that defines one or more apertures through which infrared emissions are received. The grille can define one or more reception beams in which infrared emissions can be received. A cumulative beam reception angle is defined by the angular range at which infrared emissions can be received by a particular proximity sensor component. In one or more embodiments, to provide 360-degree coverage about the housing of the electronic device, the cumulative beam reception angle for each proximity sensor component is obtuse such that it overlaps with at least one other beam reception angle of at least one other proximity sensor component.

The definition of such reception beams advantageously can enable the proximity sensor components to detect not only the location of an object relative to the housing, but also whether one or multiple objects are within a thermal detection radius. Embodiments of the disclosure contemplate that there is a high value in not only detecting presence or motion of a user in a 360-degree coverage area provided by the proximity sensor components, but also in determining where the exact user position is relative to electronic device to determine whether people can see the display. The use of the grille and its corresponding reception beams allows for the detection of multiple people about the housing of the electronic device, even when those people are close to one another. Advantageously, in one or more embodiments this can be detected by sensing infrared emissions by those persons via the reception beams and overlapping the cumulative beam reception angle.

By determining which proximity sensor component, or combination of components, receives an infrared emission, one or more processors of the electronic device can determine where a person or persons may be located about the electronic device. Said differently, in one embodiment the one or more processors can determine whether a single proximity sensor component or multiple proximity sensor components receives the infrared emission to determine a relative location of either a single person or a plurality of people relative to the housing of the electronic device.

Turning briefly to FIG. 6, illustrated therein are some other techniques for determining whether two or more people are within an environment of the electronic device. Others will be obvious to those of ordinary skill in the art having the benefit of this disclosure.

In one or more embodiments, decision 402 determines whether two or more people are within the predefined environment of the electronic device by detecting other electronic devices at step 601 using local area network communications such Bluetooth™ communications or ultra-wide band communications. Alternatively, as described above, step 602 can comprise capturing one or more images with an imager and determining whether two or more people are within the predefined environment by performing image analysis.

Illustrating by example, an imager of the electronic device may capture an image of the predefined environment about the electronic device. Components of the electronic device can then analyze that image to determine whether multiple persons are within the predefined environment. In one embodiment one or more processors of the electronic device determine whether the one or more persons are within the predefined environment of the electronic device by capturing, with the imager, one or more images of the predefined environment and performing image analysis on images captured by the imager to determine whether multiple persons are within the predefined environment.

At step 603, audio input can be captured to determine whether one or more voices are within the predefined environment. Said differently, decision 402 can made using audio analysis at step 603. An audio input/processing system may capture audio from the predefined environment and can analyze this audio input to detect multiple persons within the predefined environment.

At step 604, user input indicating that there are multiple people within the environment can be received as well. A user may deliver user input to the user interface of the electronic device that indicates two or more people are within the predefined environment. When the user authentication code entry field is presented, for example, the user may enter ****, rather than the actual personal identification number, to alert the one or more processors of the electronic device that multiple persons are within the predefined environment.

These techniques shown in FIG. 6 are in addition to those described above with reference to FIG. 3, which includes querying a calendaring application to determine whether a scheduled appointment stored in the calendaring application identifies a multi-person gathering or when a location detector detects an electronic device being in a public location such as an office, train, or restaurant. Other techniques will be obvious to those of ordinary skill in the art having the benefit of this disclosure.

Turning now back to FIG. 4, when multiple people are within the predefined environment of the electronic device step 403 comprises causing one or more of a financial application, banking application, or messaging application to operate in a security mode of operation. In one or more embodiments, step 403 comprises the one or more processors of the electronic device setting a security mode of operation flag to true. Otherwise, the method 400 moves to step 408 where the one or more of the messaging application, banking application, or financial application operate in a normal mode of operation.

At step 404, when two or more people are in the environment of the electronic device, the one or more processors mask numerical financial data from being presented on the display of the electronic device. Illustrating by example, the one or more processors may mask financial transaction amounts or bank balances prior to their being presented on the display of the electronic device.

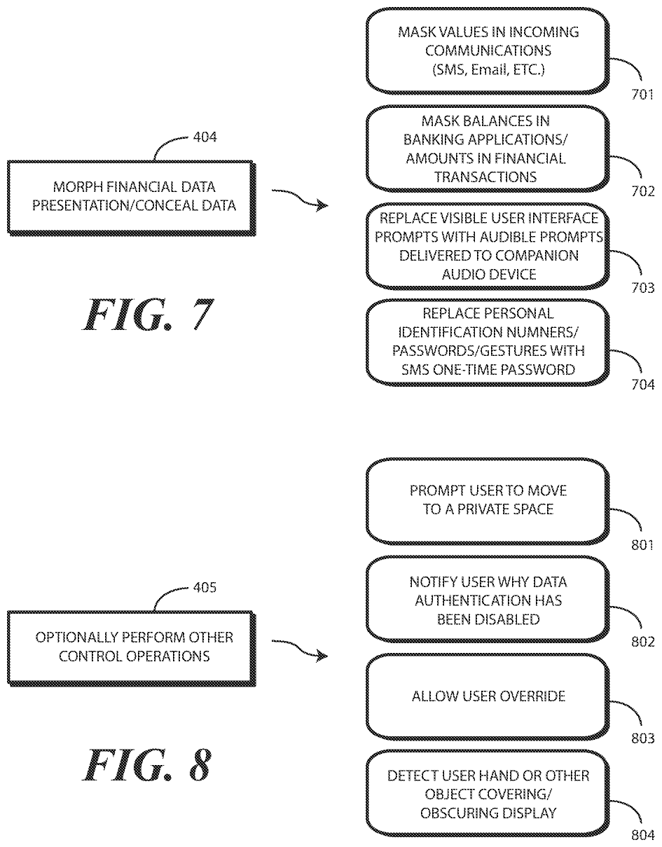

Turning briefly to FIG. 7, illustrated therein are several techniques for precluding the presentation of numerical financial data when one or more applications are operating in a security mode of operation at step 404. Illustrating by example, step 404 can comprise, at step 701, masking numerical financial representations appearing in incoming communications received by a communication device and rendered for presentation on the display of an electronic device. Similarly, step 702 can comprise masking bank balances or financial transaction amounts of a banking application or financial application.

Step 703 can comprise converting visual prompts generated by financial applications, banking applications, or appearing in messages received by a messaging application into audio prompts. Step 703 can further comprise causing a communication device of the electronic device to deliver the audio prompts to a companion audio device.

At step 704, the security mode of operation of step 404 can preclude the usage of a personal identification number, personal identification gesture, or password to authenticate an authorized user of one or more of a banking application, financial application, or messaging application. Instead, step 704 can require the entry of a one-time password to authenticate the authorized user to the one or more of the financial application, banking application, or messaging application.

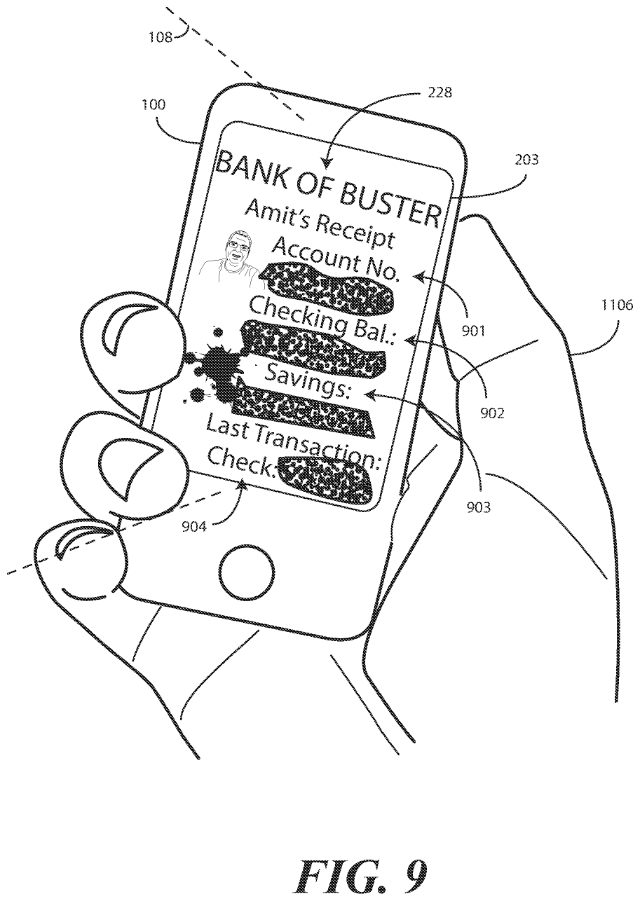

Turning now back to FIG. 4, at step 405 other control operations can optionally be performed. Turning briefly to FIG. 8, illustrated therein are several examples of such optional control operations. Others will be obvious to those of ordinary skill in the art having the benefit of this disclosure.

In one embodiment, step 405 comprises prompting, with the one or more processors at the user interface, for the person to move the electronic device to a location where the person is the only person within the predefined environment at step 801. Step 801 can further comprise detecting, with one or more location detectors, both movement of the electronic device to a new location and only one person being within the predefined environment. Where this occurs, the method (400) of FIG. 4 can move from step 405 to step (408), and thereafter cause banking applications and financial applications to operate in a normal mode of operation.

In one embodiment, step 405 can comprise presenting a notification, with the one or more processors at the user interface at step 802, that the presentation of numerical financial data has been precluded at step (404). Step 802 can further comprise presenting a notification why the presentation of numerical financial data has been precluded.

In one embodiment, step 803 can comprise allowing the user to override the preclusion of step (404) of FIG. 4. Illustrating by example, step 803 can include prompting, at the user interface when the two or more persons are within the predefined environment, for the entry of a user input overriding preclusion of the presentation of numerical financial data. Step 803 can then include receiving, from the user interface after the prompting, the user input overriding preclusion of the presentation of numerical financial data and, after receiving the user input, transforming the operation of banking applications, messaging applications, and financial applications to a normal mode of operation.

In one embodiment, step 405 can comprise, with the one or more other sensors, shielding of the user interface of the electronic device at step 804. This can be accomplished, for example, by capturing an image of a hand over the display, detecting low light at the display with a light detector, or other techniques. Where this occurs, the method (400) of FIG. 4 can move from step 405 to step (408), thereafter operating banking applications and financial applications in a normal mode of operation.

Turning now back to FIG. 4, decision 406 can again check to see if two or more persons are within the predefined environment of the electronic device. Decision 406 can be performed using techniques described above with reference to decision 402, with reference to FIG. 5, with reference to FIG. 3, or combinations thereof. Where only one person is within the predefined environment, step 407 can set the security mode of operation flag to false. Thereafter, step 408 can operate one or more of the messaging applications, the financial applications, and/or the banking applications in a normal mode of operation. In one or more embodiments, this comprises omitting the masking of any bank balance or financial transaction amount.

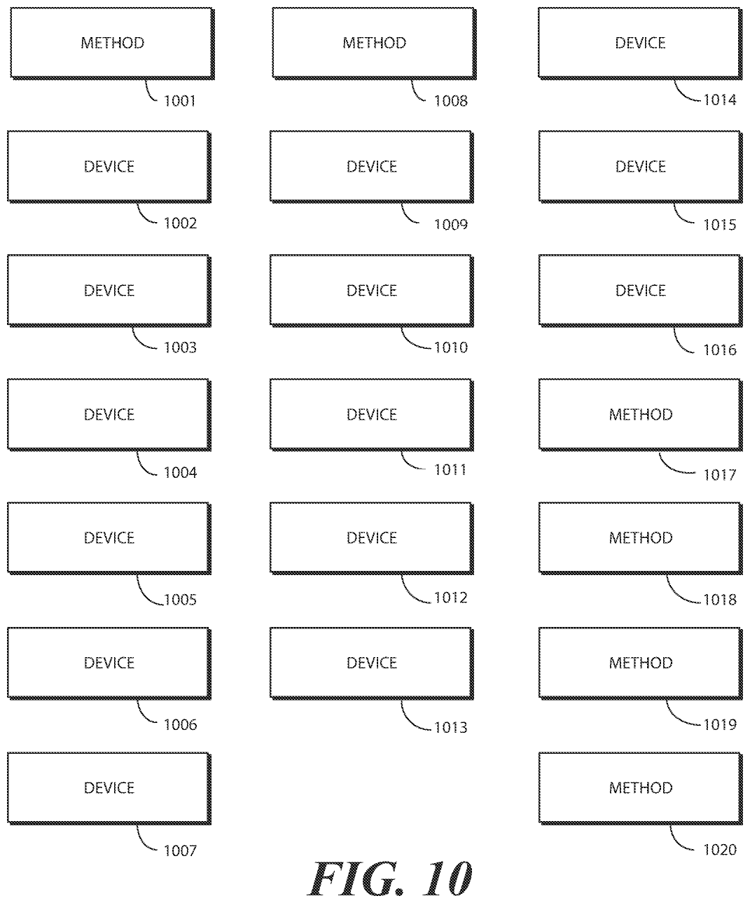

Turning now to FIG. 10, illustrated therein are various embodiments of the disclosure. The embodiments of FIG. 107 are shown as labeled boxes in FIG. 10 due to the fact that the individual components of these embodiments have been illustrated in detail in FIGS. 1-9, which precede FIG. 10. Accordingly, since these items have previously been illustrated and described, their repeated illustration is no longer essential for a proper understanding of these embodiments. Thus, the embodiments are shown as labeled boxes.

At 1001, an electronic device comprises a user interface comprising a display, one or more sensors, a communication device, and one or more processors operable with the user interface, the one or more sensors, and the communication device. At 1001, the one or more processors determine, with the one or more sensors, whether one or more persons are within a predefined environment of the electronic device.

At 1001, where only one person is within the predefined environment, the one or more processors operate one or more of a financial application, a messaging application, or a banking application in a normal mode of operation. By contrast, at 1001 where two or more persons are within the predefined environment, the one or more processors operate the one or more of the financial application, the messaging application, or the banking application in a security mode of operation.

At 1002, the one or more of the financial application, the messaging application, or the banking application of 1001 comprises the messaging application. At 1002, the security mode of operation masks numerical financial representations appearing in incoming communications received by the communication device and rendered for presentation on the display by the messaging application.

At 1003, the one or more of the financial application, the messaging application, or the banking application of 1001 comprises the banking application. At 1003, the security mode of operation masks bank balances rendered for presentation on the display by the banking application.

At 1004, the one or more of the financial application, the messaging application, or the banking application of 1001 comprises the financial application. At 1004, the security mode of operation masks financial transaction amounts rendered for presentation on the display by the financial application.

At 1005, the security mode of operation of 1001 converts visual prompts generated by the one or more of the financial application, the messaging application, or the banking application into audio prompts. At 1005, the one or more processors further cause the communication device to deliver the audio prompts to a companion audio device.

At 1006, the security mode of operation of 1001 precludes usage of a personal identification number, personal identification gesture, or password to authenticate an authorized user of one or more of the financial application, the messaging application, or the banking application. At 1007, the security mode of operation of 1006 further requires entry of a one-time password to authenticate the authorized user to the one or more of the financial application, the messaging application, or the banking application.

At 1008, the one or more processors of 1007 further prompt, at the user interface when the two or more persons are within the predefined environment, for the electronic device to be moved to a location where the only one person is within the predefined environment. At 1009, the one or more processors of 1007 further present indicia, at the user interface when the two or more persons are within the predefined environment. At 1009, the indicia indicate that the usage of the personal identification number, the personal identification gesture, or the password to authenticate the authorized user of the one or more of the financial application, the messaging application, or the banking application has been precluded.

At 1010, the one or more processors of 1007 further prompt, at the user interface when the two or more persons are within the predefined environment, for the entry of a user input overriding preclusion of the usage of the personal identification number, the personal identification gesture, or the password to authenticate the authorized user of the one or more of the financial application, the messaging application, or the banking application. At 1010, the one or more processors receive, from the user interface after the prompting, the user input overriding the preclusion of the usage of the personal identification number, the personal identification gesture, or the password to authenticate the authorized user of the one or more of the financial application, the messaging application, or the banking application. At 1010, after receiving the user input, the one or more processors request, at the user interface, the entry of the personal identification number, the personal identification gesture, or the password to authenticate the authorized user of the one or more of the financial application, the messaging application, or the banking application.

At 1011, the one or more sensors of 1001 comprise an imager. At 1011, the one or more processors determine whether the one or more persons are within the predefined environment of the electronic device by capturing, with the imager, one or more images of the predefined environment.

At 1012, the one or more sensors of 1001 comprise a location detector. At 1012, the one or more processors determine whether the one or more persons are within the predefined environment of the electronic device by detecting, from signals from the location detector, that the electronic device is situated in a public location.

At 1013, the one or more processors of 1010 determine whether the one or more persons are within the predefined environment by querying a calendaring application operating on the one or more processors to detect a scheduled appointment stored in the calendaring application that identifies a multi-person gathering. At 1014, the one or more processors of 1001 determine whether the one or more persons are within the predefined environment when user input indicating the same is received by the user interface.

At 1015, an electronic device comprises a user interface, one or more sensors, and one or more processors operable with the user interface and the one or more sensors. At 1015, the one or more processors, in response to an application operating on the one or more processors rendering numerical financial data for presentation on the user interface, determine with the one or more sensors that two or more persons are within a field of view of the user interface. At 1015, where the two or more persons are within the field of view of the user interface, the one or more processors preclude presentation of the numerical financial data at the user interface.

At 1016, the one or more processors of 1015 preclude presentation of the numerical financial data on the user interface my masking the numerical financial data. At 1017, the one or more processors of 1015 preclude presentation of the numerical financial data on the user interface by converting the numerical financial data to audio signals for delivery to an audio output device.

At 1018, a method in an electronic device comprises detecting, with one or more processors, an application operating on the one or more processors rendering a financial transaction amount or bank balance for presentation on a user interface. At 1018, the method comprises determining, with one or more sensors of the electronic device, that two or more persons are within a predefined environment of the electronic device. At 1018, when the two or more persons are within the predefined environment, the method comprises masking, with one or more processors, the financial transaction amount or the bank balance prior to their presentation on the user interface.

At 1019, the method of 1018 further comprises detecting, with one or more location detectors, both movement of the electronic device to a new location and only one person being within the predefined environment, and thereafter omitting the masking of the financial transaction amount or the bank balance. At 1020, the method of 1018 further comprises detecting, with the one or more sensors, shielding of the user interface of the electronic device, and thereafter omitting the masking of the financial transaction amount or the bank balance.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example the determination of whether multiple persons are within an environment may be triggered by one or more motion sensors of the electronic device. When, for instance, an electronic device is sitting on a table and in a locked state, an imager can be actuated when the electronic device is moved. When this occurs the imager can determine whether the electronic device is in a public or private setting. If the setting is public, one or more processors can preclude the presentation of numerical financial data.

When in the private mode, an imager or audio sensor can detect that the person is the only person in the environment, perhaps by capturing images of the electronic device being tightly coupled with the user or by a light sensor indicating shadows when the user covers the display with the hand. Where this occurs, the presentation of numerical financial data can be enabled. Thus, when a user is attempting to engage in a financial transaction in a public environment, the presentation of numerical financial representations is precluded. In one or more embodiments a prompt is presented on the display indicating why this is the case, as described above.

Advantageously, when someone, such as a friend or family member or a stranger, is detected to be looking at a display of an electronic device and is within a readable range/distance from the electronic device, the presentation of financial transaction amounts or bank balances is disabled. Reasons why this is occurring can be presented on the display so that the user understands what is happening. During such numerical financial data presentation preclusion states, one or more processors of the electronic device can provide other options to obtain this data, e.g., by converting the numerical financial data to audio and delivering the audio to a private companion audio output device.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. An electronic device, comprising:
a user interface comprising a display;
one or more sensors;
a communication device; and
one or more processors operable with the user interface, the one or more sensors, and the communication device;
the one or more processors determining, with the one or more sensors, whether one or more persons are within a predefined environment of the electronic device; and
where only one person is within the predefined environment, operating one or more of a financial application, a messaging application, or a banking application in a normal mode of operation; and
where two or more persons are within the predefined environment, operating the one or more of the financial application, the messaging application, or the banking application in a security mode of operation.

2. The electronic device of claim 1, wherein:
the one or more of the financial application, the messaging application, or the banking application comprises the messaging application; and
the security mode of operation masks numerical financial representations appearing in incoming communications received by the communication device and rendered for presentation on the display by the messaging application.

3. The electronic device of claim 1, wherein:
the one or more of the financial application, the messaging application, or the banking application comprises the banking application; and
the security mode of operation masks bank balances rendered for presentation on the display by the banking application.

4. The electronic device of claim 1, wherein:
the one or more of the financial application, the messaging application, or the banking application comprises the financial application; and
the security mode of operation masks financial transaction amounts rendered for presentation on the display by the financial application.

5. The electronic device of claim 1, wherein the security mode of operation converts visual prompts generated by the one or more of the financial application, the messaging application, or the banking application into audio prompts, further comprising causing, by the one or more processors, the communication device to deliver the audio prompts to a companion audio device.

6. The electronic device of claim 1, wherein the security mode of operation precludes usage of a personal identification number, personal identification gesture, or password to authenticate an authorized user of one or more of the financial application, the messaging application, or the banking application.

7. The electronic device of claim 6, wherein the security mode of operation further requires entry of a one-time password to authenticate the authorized user to the one or more of the financial application, the messaging application, or the banking application.

8. The electronic device of claim 7, the one or more processors further prompting, at the user interface when the two or more persons are within the predefined environment, for the electronic device to be moved to a location where the only one person is within the predefined environment.

9. The electronic device of claim 7, the one or more processors further presenting indicia, at the user interface when the two or more persons are within the predefined environment, the indicia indicating that the usage of the personal identification number, the personal identification gesture, or the password to authenticate the authorized user of the one or more of the financial application, the messaging application, or the banking application has been precluded.

10. The electronic device of claim 7, the one or more processors further:
prompting, at the user interface when the two or more persons are within the predefined environment, for the entry of a user input overriding preclusion of the usage of the personal identification number, the personal identification gesture, or the password to authenticate the authorized user of the one or more of the financial application, the messaging application, or the banking application;
receiving, from the user interface after the prompting, the user input overriding the preclusion of the usage of the personal identification number, the personal identification gesture, or the password to authenticate the authorized user of the one or more of the financial application, the messaging application, or the banking application; and
after receiving the user input, requesting, at the user interface, the entry of the personal identification number, the personal identification gesture, or the password to authenticate the authorized user of the one or more of the financial application, the messaging application, or the banking application.

11. The electronic device of claim 1, the one or more sensors comprising an imager, the one or more processors determining whether the one or more persons are within the predefined environment of the electronic device by capturing, with the imager, one or more images of the predefined environment.

12. The electronic device of claim 1, the one or more sensors comprising a location detector, the one or more processors determining whether the one or more persons are within the predefined environment of the electronic device by detecting, from signals from the location detector, that the electronic device is situated in a public location.

13. The electronic device of claim 1, the one or more processors determining whether the one or more persons are within the predefined environment by querying a calendaring application operating on the one or more processors to detect a scheduled appointment stored in the calendaring application that identifies a multi-person gathering.

14. The electronic device of claim 1, the one or more processors determining whether the one or more persons are within the predefined environment when user input indicating the same is received by the user interface.

15. An electronic device, comprising:
a user interface;
one or more sensors; and
one or more processors operable with the user interface and the one or more sensors;
the one or more processors, in response to an application operating on the one or more processors rendering numerical financial data for presentation on the user interface, determining with the one or more sensors that two or more persons are within a field of view of the user interface, and where the two or more persons are within the field of view of the user interface, precluding presentation of the numerical financial data at the user interface.

16. The electronic device of claim 15, the one or more processors precluding presentation of the numerical financial data on the user interface by masking the numerical financial data.

17. The electronic device of claim 15, the one or more processors precluding presentation of the numerical financial data on the user interface by converting the numerical financial data to audio signals for delivery to an audio output device.

18. A method in an electronic device, the method comprising:
detecting, with one or more processors, an application operating on the one or more processors rendering a financial transaction amount or bank balance for presentation on a user interface;
determining, with one or more sensors of the electronic device, that two or more persons are within a predefined environment of the electronic device; and
when the two or more persons are within the predefined environment, masking, with one or more processors, the financial transaction amount or the bank balance prior to their presentation on the user interface.

19. The method of claim 18, further comprising detecting, with one or more location detectors, both movement of the electronic device to a new location and only one person being within the predefined environment, and thereafter omitting the masking of the financial transaction amount or the bank balance.

20. The method of claim 18, further comprising detecting, with the one or more sensors, shielding of the user interface of the electronic device, and thereafter omitting the masking of the financial transaction amount or the bank balance.
